(19) United States
(12) Patent Application Publication
(10) Pub. No.: US 2004/0256166 A1
(43) Pub. Date: Dec. 23, 2004

(54) Cart mover

(76) Inventors: Paul D. Holtan, Savage, MN (US); Daniel T. Johnson, Medina, MN (US)

Correspondence Address: S. Wade Johnson, Esq., DORSEY & WHITNEY LLP, Intellectual Property Department, 50 South Sixth Street, Suite 1500, Minneapolis, MN, 55402-1498, US

(21) Appl. No.: 10/836,593

(22) Filed: Apr. 30, 2004

Related U.S. Application Data
(60) Provisional application No. 60/467,441, filed on May 3, 2003.

(51) Int. Cl. B62B 1/00

(52) U.S. Cl. 180/65.5

(57) ABSTRACT

The present invention, in one embodiment, is a device for moving a heavy cart, such as a bossie cart used to transport one-gallon jugs of milk in a bulk-milk facility. The device includes a body that has an operator platform, a steerable drive wheel and a plurality of castors that support the body, a steering tiller that is interconnected to the steerable drive wheel, and a hitch that is attached to the body and includes a fixed jaw and a movable jaw interconnected by a center structure. The jaws are adapted to engage opposite sides of the cart as the device is used to move the cart.

### CROSS-REFERENCE TO RELATED APPLICATION

This application claims priority to U.S. provisional patent application 60/467,441, filed May 3, 2003, which is hereby incorporated by reference in its entirety.

### FIELD OF THE INVENTION

The present invention relates to apparatus and methods for attaching to and moving a cart or platform. More specifically, the present invention relates to apparatus and methods for assisting a person in moving a cart or platform.

### BACKGROUND OF THE INVENTION

In many areas, commercial milk sales to retail grocery stores involve stainless steel carts loaded with one-gallon milk jugs. Each cart holds 80 or 120 one-gallon milk jugs. Because the carts hold milk, they are nicknamed “bossie carts” after Bossie the cow. At bulk-milk facilities, automatic machines load the carts with the one-gallon milk jugs. The loaded carts are then trucked to retail stores where the one-gallon milk jugs are sold. At the retail store, a loaded cart is stored in a cooler until it is time to sell its one-gallon milk jugs. When the sale time arrives, the loaded cart is rolled into a position where its side is adjacent to an open-sided display cooler. This allows the customer to pick the milk right off the cart.

When loaded, an 80-gallon cart will weigh about 800 pounds, and a 120-gallon cart will weigh about 1200 pounds. Typically, an 80-gallon cart will ride on two fixed castors and two swivel castors, while a 120-gallon cart will ride on either two fixed castors and two swivel castors or four swivel castors.

At some bulk milk facilities, machines automatically move the loaded carts from the automatic loading machine to the storage coolers and delivery trucks. However, at other bulk milk facilities, the loaded carts are moved by hand from the automatic loading machine to the storage coolers and delivery trucks. Typically, a person grabs a loaded cart with both hands at waist height or higher and walks the loaded cart to the next location. The job of moving the loaded carts is physically taxing because the loaded carts are very heavy and many loaded carts are moved each day. The job is further complicated. by floors that are wet and slippery with liquid, which is almost always the condition of the floors within a bulk milk facility. Because of these conditions, numerous injuries occur.

In other industries, products (e.g., food items, beverages, consumer goods, items of manufacture or processing, etc.) are loaded onto platforms or stands that are equipped with rollers, wheels or air bearings (i.e., hovercraft-type arrangements wherein the platform or stand rides on a cushion of air). These platforms or stands are then moved by one or more persons physically pushing or pulling on the platform or stand. Again, because of the weight of such platforms or stands, their manual movement can be physically taxing and can result in injury to the persons involved in moving the platforms or stands.

There is a need in the art for an apparatus that allows a person to manually move a heavy cart or platform without great physical exertion. There is also a need in the art for a method of moving a loaded bossie cart without great physical exertion on the person's part.

### BRIEF SUMMARY OF THE INVENTION

The present invention, in one embodiment, is a device for moving a bossie cart. The device comprises a body including an operator platform, a steerable drive wheel and a plurality of castors that support the body, a steering tiller that is interconnected to the steerable drive wheel, and a hitch that is attached to the body and includes a fixed jaw and a movable jaw interconnected by a center structure. The jaws are adapted to engage opposite sides of the bossie cart.

The present invention, in another embodiment, is a hitch for attaching to a bossie cart. The hitch comprises a center structure, a fixed jaw, a moveable jaw, a secondary hitch, a linkage, and an actuator. The center structure has a first end and a second end. The fixed jaw is secured to the first end and the movable jaw is pivotally secured to the second end. The secondary hitch is pivotally secured to the center structure between the two ends. The linkage mechanism pivotally moves the movable jaw and the secondary hitch. The actuator is adapted to move the linkage to cause the movable jaw and the secondary hitch to engage the bossie cart.

The present invention, in one embodiment, is a castor alignment lock. The castor includes a wheel and a vertical pivot pin. The wheel is rotatable about a horizontal axis and pivotable about the vertical pivot pin. The castor alignment lock comprises two or more vertical bearing studs interconnected to the vertical pivot pin, a cam adapted to engage the bearing studs, and an actuator adapted to bring the cam into engagement with the bearing studs. The cam prevents the wheel from pivoting about the vertical pivot pin when the cam has engaged the bearing studs.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a front perspective view of a cart mover, according to one embodiment of the present invention.

FIG. 2 is a rear perspective view of the cart mover shown in FIG. 1.

FIG. 3 is a side perspective view of the cart mover being used by an operator to move a bossie cart.

FIG. 4 is a plan view of a clamping hitch in the open position.

FIG. 5 is a front elevation view of the clamping hitch in the open position.

FIG. 6 is a plan view of the clamping hitch in the closed position.

FIG. 7 is a front elevation view of the clamping hitch in the closed position.

FIG. 8 is a plan view of the linkage system for the clamping hitch.

FIG. 9 is rear elevation view of the linkage system for the clamping hitch.

FIG. 10 is a plan view of the auto-steer mechanism in the open position.

FIG. 11 is a plan view of the auto-steer mechanism in the closed position.

FIG. 12 is a side elevation view of the auto-steer mechanism in the open position.

FIG. 13 is a side elevation view of the auto-steer mechanism in the closed position.

FIG. 14 is a side perspective view of the auto-steer mechanism in the open position.

FIG. 15 is a back elevation view of the manual brake mechanism with the brake locked.

FIG. 16 is a back elevation view of the manual brake mechanism with the brake released.

FIG. 17 is a side elevation view of the manual brake mechanism with the brake released.

FIG. 18 is bottom view of the manual brake mechanism with the brake locked.

FIG. 19 is a bottom view of the manual brake mechanism with the brake released.

FIG. 20 is a side perspective view of the manual brake mechanism with the brake released.

FIG. 21 is a rear perspective view of the tiller latch engaged.

FIG. 22 is a rear perspective view of the tiller latch disengaged.

FIG. 23 is a front perspective view of the cart mover with the tiller latch disengaged and the tiller in a horizontal position.

FIG. 24 is a front perspective view of the cart mover with the hitch positioned to engage a cart.

FIG. 25 is a plan view of the cart mover with the hitch positioned to engage a cart.

FIG. 26 is a plan view a of the cart mover with the hitch positioned to engage a cart.

FIG. 27 is a plan view of a telescoping finger equipped jaw shown in FIG. 26.

FIG. 28 is a side elevation view of the telescoping finger equipped jaw.

FIG. 29 is an exploded isometric view of the telescoping finger equipped jaw.

### DETAILED DESCRIPTION

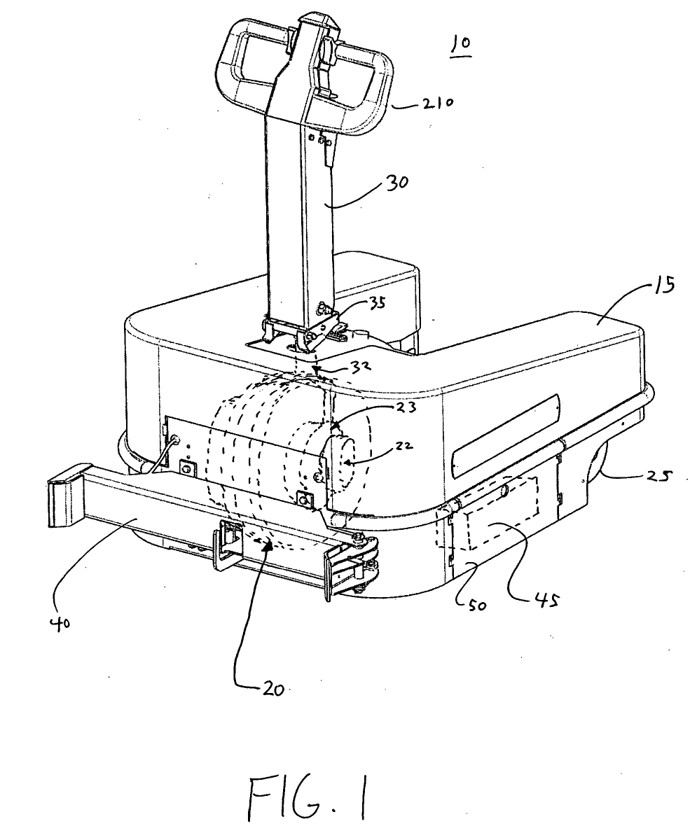

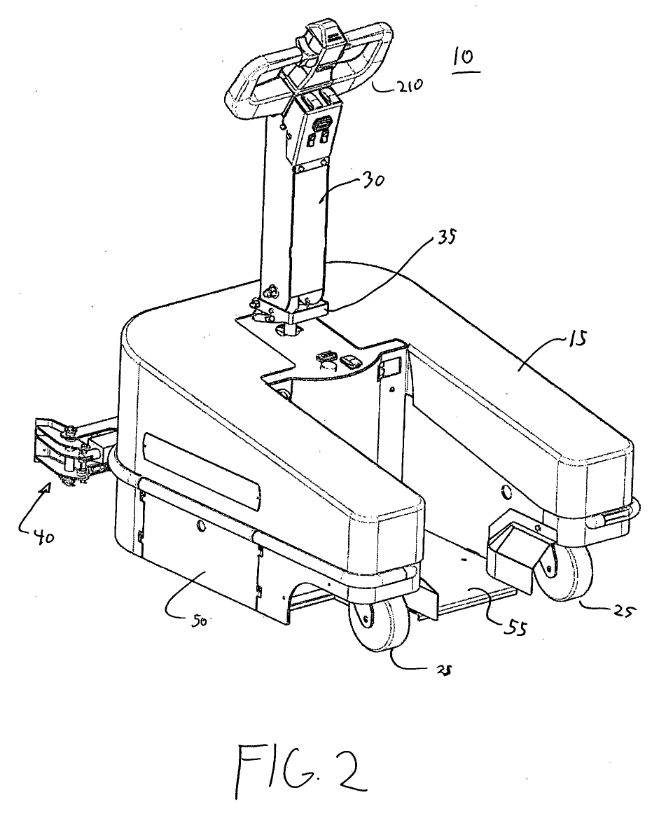

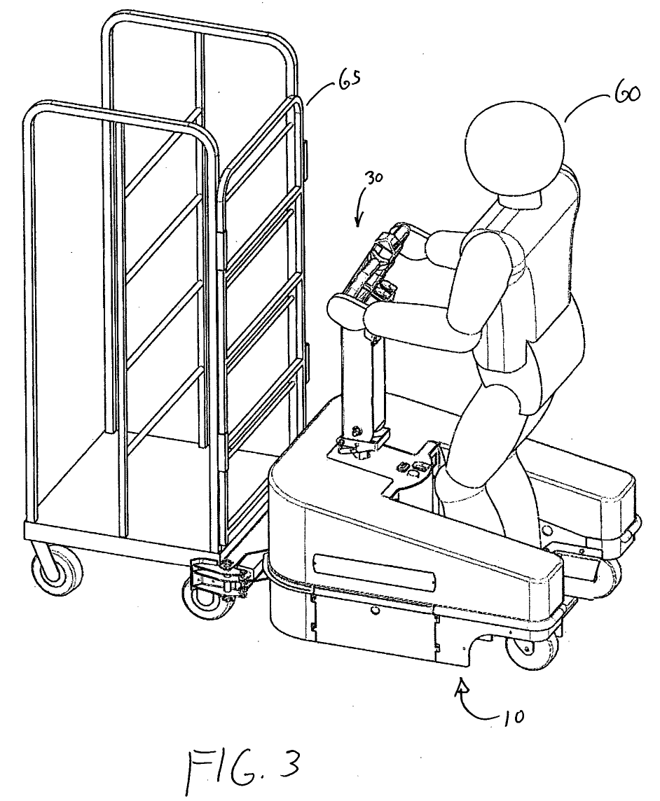

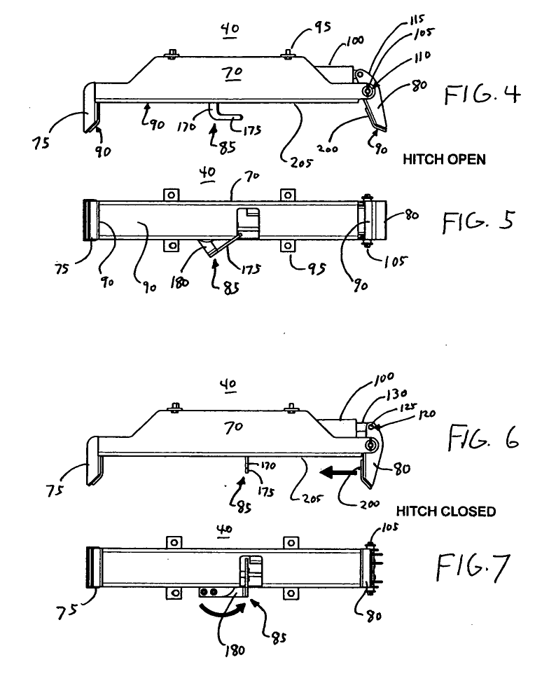

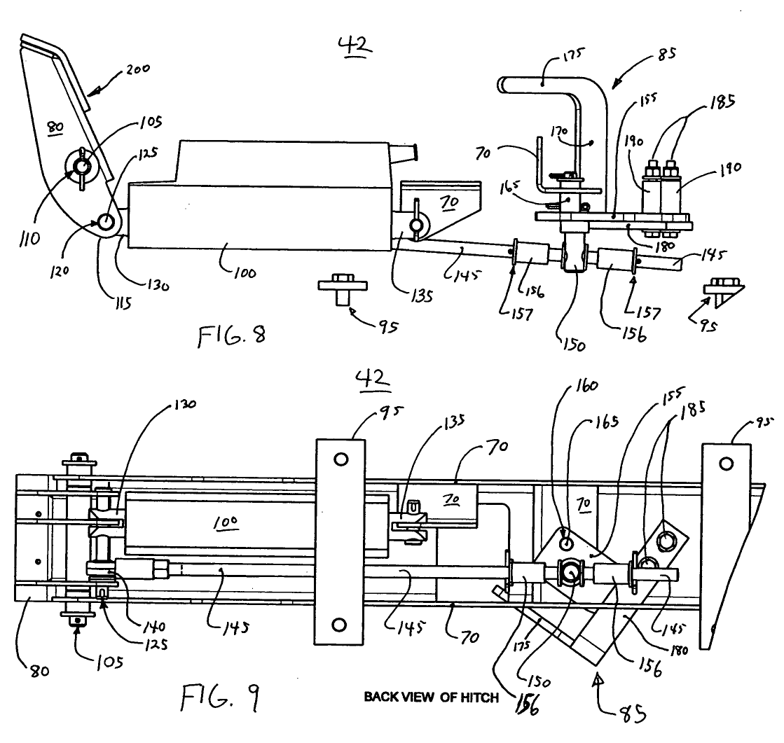

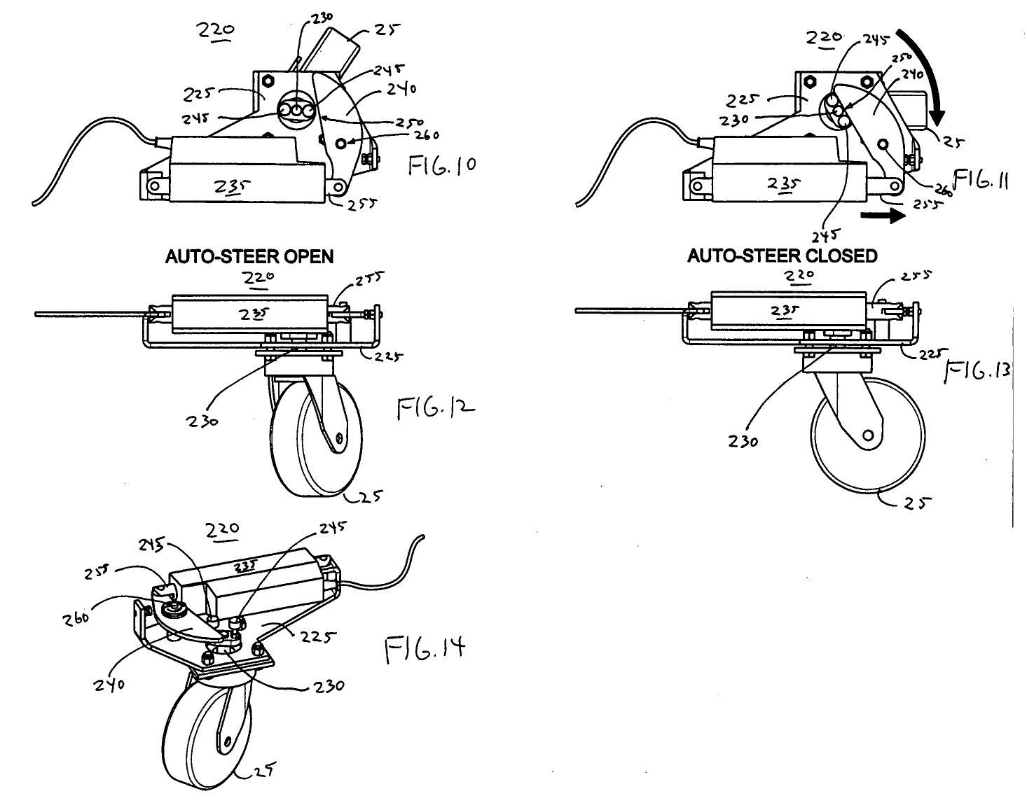

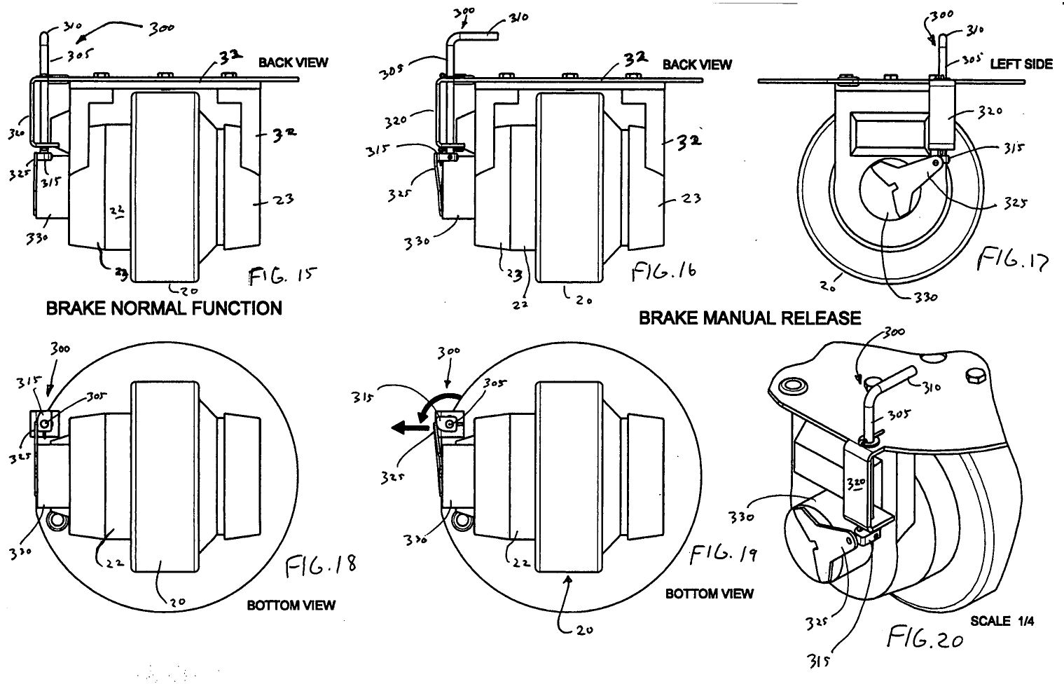

FIG. 1 is a front perspective view of the subject invention, a cart mover 10. The cart mover 10 can be hitched to a cart or moveable platform that is heavily loaded with products (e.g., food items, beverages, consumer goods, items of manufacture or processing, etc.). A person can then utilize the cart mover 10 to easily move and control the heavily loaded cart. Thus, the cart mover 10 makes it possible for a person to move a heavily loaded cart without subjecting the person to great physical exertion or injury.

As shown in FIG. 1, the cart mover 10 includes a body 15, a steerable drive wheel 20 (shown in phantom), an integral gear box/motor assembly 22 (shown in phantom) mounted in the hub of the wheel, a wheel housing 23 (shown in phantom), a pair of castor wheels 25, a tiller 30, a steerable shaft 32, a tiller latch 35, a clamping hitch 40, a rechargeable battery 45 (shown in phantom), and a battery access door 50. The battery 45 powers the integral gear box/motor assembly 22, which drives the drive wheel 20. The tiller 30 is attached to the steerable shaft 32, which is attached to the wheel housing 23. The drive wheel 20 and the castor wheels 25 support the cart mover 10. In one embodiment, the steerable drive wheel 20 has approximately 180 degrees of steering travel. In one embodiment, the motor 22 is 24 volt DC electric.

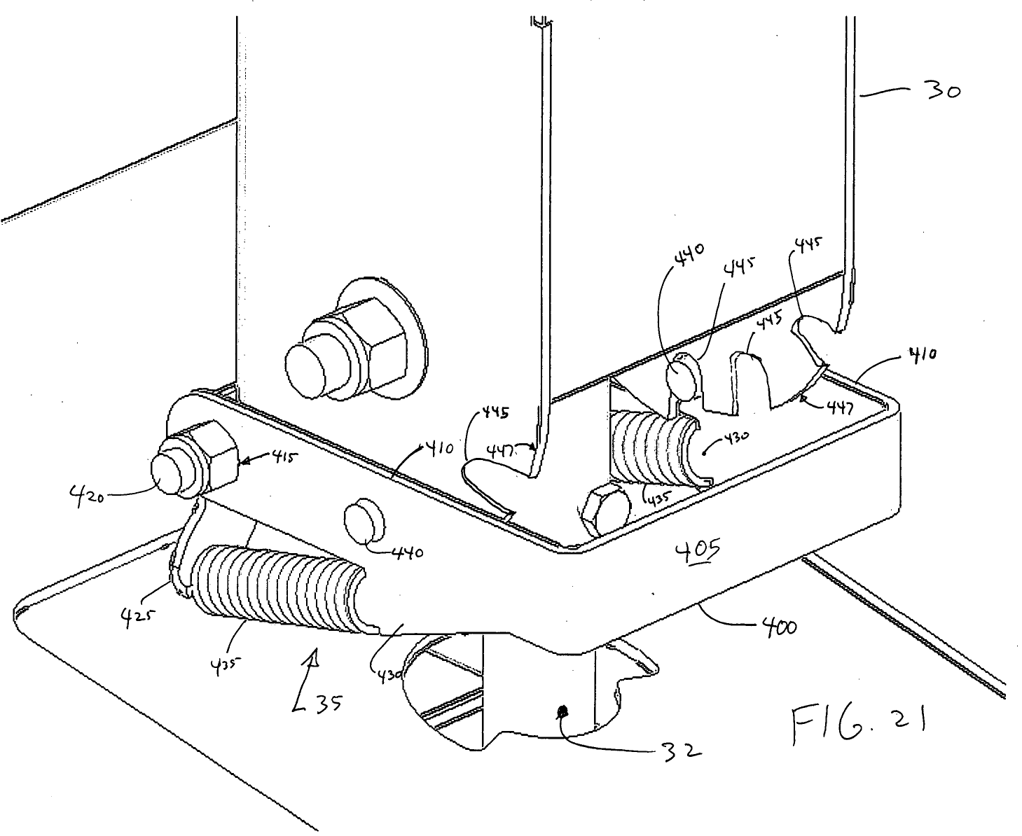

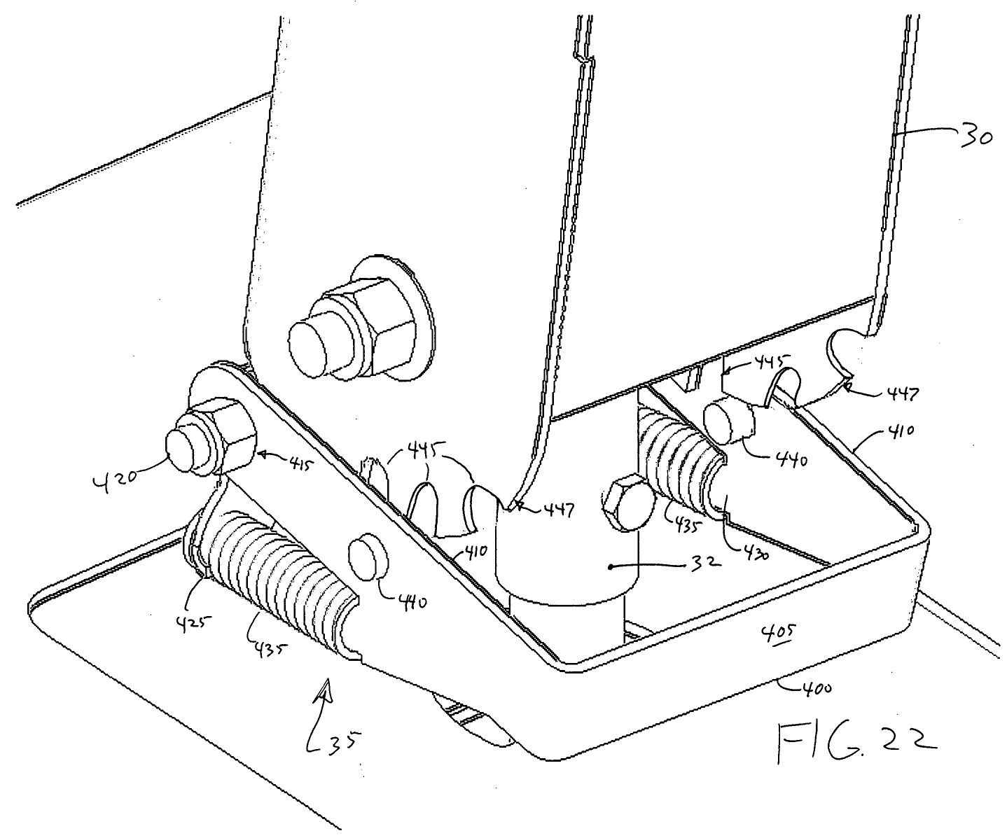

FIG. 2 is a rear perspective view of the cart mover 10. As illustrated in FIG. 2, the cart mover 10 has a platform 55 on which an operator stands while operating the cart mover 10. When the operator stands on the platform 55 of the cart mover 10, the operator's weight increases the traction of the drive wheel 20. As indicated in FIG. 2, the body 15 of the cart mover, when viewed from above, forms a “U” shape.

FIG. 3 is a side perspective view of the cart mover 10 being used by an operator 60 to move a bossie cart 65. As shown in FIG. 3, the cart mover 10 is hitched to the bossie cart 65, and the operator 60 uses the tiller 30 to maneuver the cart mover 10 and attached bossie cart 65. Thus, the cart mover 10 allows an operator 60 to move bossie carts 65 through a bulk milk facility, or through other facilities where bossie carts 65 are found, with minimal physical effort, thereby reducing the operator's exposure to the hazards of manual cart moving. Similarly, in other industries, the cart mover 10 can also be configured to move carts that are adapted to carry other products (e.g., food items, beverages, consumer goods, items of manufacture, etc.).

To describe one embodiment of the clamping hitch 40, reference is now made to FIGS. 4-9. FIG. 4 is a plan view of the clamping hitch 40 in the open position, and FIG. 5 is a front elevation view of the clamping hitch 40 in the open position. FIG. 6 is a plan view of the clamping hitch 40 in the closed position, and FIG. 7 is a front elevation view of the clamping hitch 40 in the closed position. FIG. 8 is a plan view of the linkage system 42 for the clamping hitch 40, and FIG. 9 is rear elevation view of the linkage system 42 for the clamping hitch 40.

As shown in FIGS. 4-7, the clamping hitch 40 has a center support 70, a fixed jaw 75, a movable jaw 80, a secondary latch 85, a protective belting 90, attachment points 95 for attaching the clamping hitch 40 to the body 15 of the cart mover 10, an electric actuator 100 that is part of the linkage system 42, and a pivot pin 105. The fixed jaw 75 is rigidly attached to one end of the center support 70, and the movable jaw 80 is pivotally attached by the pivot pin 105 to the other end of the center support 70.

In use, the cart mover 10 approaches an end of the cart 65 with the moveable jaw 80 pivoted outwardly to the maximum extent (see FIG. 4). The end of the cart 65 is positioned between the jaws 75, 80 such that each jaw 75, 80 is immediately adjacent a lateral side of the cart 65 and the face 205 of the center support 70 is immediately adjacent the end side of the cart 65. The moveable jaw 80 is pivoted inwardly until each jaw 75, 80 is brought into solid contact with its respective lateral side of the cart 65 (see FIG. 6). The hitch 40 is now secured to the cart 65.

In an alternative embodiment of the invention, the clamping hitch 40 has a movable jaw 80 on both ends of the center support 70 and, as a result, no fixed jaw 75. Thus, during attachment of the hitch 40 to the cart 65, both jaws 75, 80 will pivot inwardly to engage their respective lateral sides of the cart 65.

In one embodiment, the face of each jaw 75, 80 is generally planar and has a protective belting 90 that increases the frictional contact between a jaw 75, 80 and its respective lateral side of the cart 65. In other embodiments, each jaw 75, 80 has a groove or other feature in its face for mating with a frame post or other structural feature of the cart 65 to help maintain the engagement between the cart 65 and the jaws 75, 80 and prevent the cart 65 from moving forwardly or rearwardly relative to the cart mover 10.

As shown in FIGS. 4-7, the protective belting 90 is located along the surfaces of the clamping hitch 40 that will abut against a bossie cart 65. In one embodiment, the belting 90 is canvas-backed rubber to protect the bossie carts 65 when pinched/gripped by the clamping hitch 40 and to provide increased frictional contact between the clamping hitch 40 and the cart 65.

As shown in FIGS. 8 and 9, the movable jaw 80 has a fulcrum hole 110 through which the pivot pin 105 is routed to secure the movable jaw 80 to the center support 70. The back end 115 of the movable jaw 80 has a pinhole 120 that is connected by a pin 125 to the shaft 130 of the electric actuator 100. The end 135 of the electric actuator 100 is pinned to the center support 70.

As illustrated in FIG. 9, the pin 125 connecting the shaft 130 to the pinhole 120 of the movable jaw 80 is also connected to a first end 140 of a linkage rod 145. The other end of the linkage rod 145 is slidably routed through a lever pin 150 that is connected to a pivot plate 155. Springs 156 encircle the linkage rod 145 on both sides of the lever pin 150 and are prevented from relocating along the rod 145, away from the lever pin 150, by stationary washers 157 secured to the rod 145. The springs 156 allow the linkage rod 145 to fully displace in either direction without damaging the secondary hitch 85 or linkage system 42, though the secondary hitch 85 may be prevented from pivoting into or out of locking position by an obstruction.

As shown in FIGS. 8 and 9, the pivot plate 155 has a fulcrum hole 160 that is pivotally connected to the center support 70 by a pivot pin 165. As indicated in FIGS. 8 and 9, the secondary hitch 85 includes a center portion 170, a finger portion 175 that forms the front of the secondary hitch 85 and is perpendicular to the center portion 170, and a back plate portion 180 that is perpendicular to the center portion 170 and is bolted by two bolts 185 to the pivot plate 155.

As illustrated in FIGS. 8 and 9, to prevent the secondary hitch 85 from being damaged by bumping against obstructions, springs 190 encompass each bolt 185 securing the back plate 180 of the secondary hitch 85 to the pivot plate 155. The springs 190 allow the back plate 180 to shift along the length of the bolts 185 relative to the pivot plate 155, thereby allowing the secondary hitch 85 to flex relative to the center support 70 when bumping against an obstruction.

As can be understood from FIGS. 8 and 9, in one embodiment, when the shaft 130 is extended from the electric actuator 100, the movable jaw 80 is in the closed position with its jaw surface 200 forming an angle with the face 205 of the center support 70 that is approximately 90 degrees, as depicted in FIGS. 6 and 7. Also, when the shaft 130 is extended from the electric actuator 100, the linkage rod 145 is shifted in the direction of the movable jaw 80 and the secondary hitch 85 is rotated about the pivot pin 165 so the finger portion 175 is vertically oriented upwards. In this configuration, the clamping hitch will attach to a bossie cart 65.

As shown in FIGS. 8 and 9, in one embodiment, when the shaft 130 is retracted into the electric actuator 100, the movable jaw 80 is in the open position with its jaw surface 200 forming an angle with the face 205 of the center support 70 that is greater than 90 degrees, as depicted in FIGS. 4 and 5. Also, when the shaft 130 is retracted in the electric actuator 100, the linkage rod 145 is shifted in the direction of the fixed jaw 75 and the secondary hitch 85 is rotated about the pivot pin 165 so the tip of the finger portion 175 resides near the bottom edge of the center support 70 and the finger portion 175 is approximately 60 degrees from being vertically oriented upwards. In this configuration, the clamping hitch 40 will release from its connection with a bossie cart 65. Whether the clamping hitch 40 is being attached to a bossie cart 65 or disengaged, the movable arm 80 and the secondary hitch 85 are electrically actuated in unison by pressing a single control button mounted on the control handles 210 of the tiller 30.

The clamping hitch 40 pinches/clamps the bossie cart 65 between the clamp's jaws 75, 80. The secondary hitch 85 pivots up to hook behind the bottom edge of a bossie cart 65.

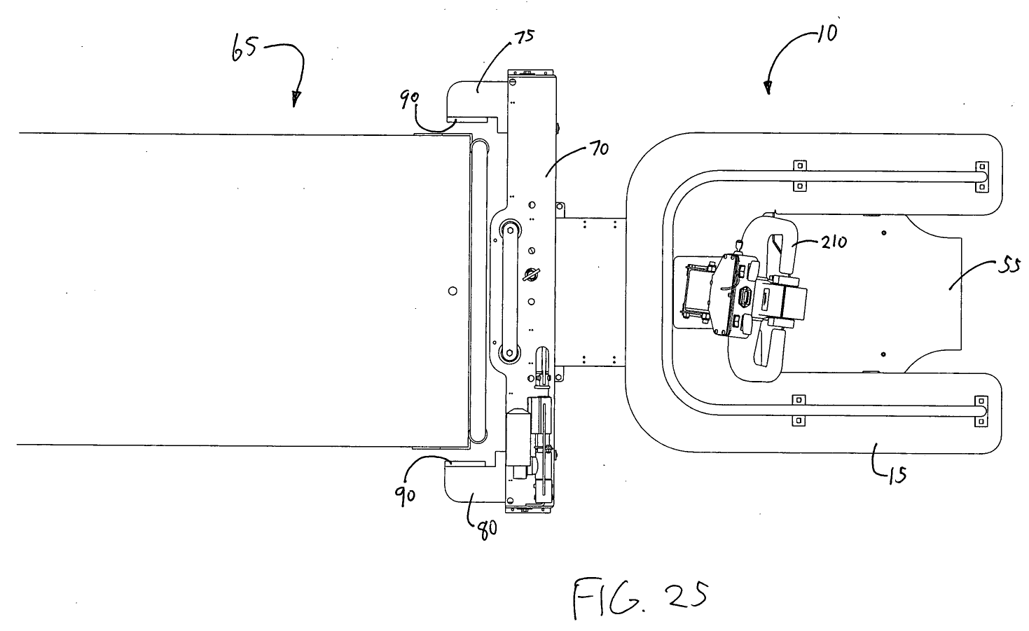

In another embodiment of the clamping hitch 40, as illustrated in FIGS. 24 and 25, which are, respectively, a front perspective view and a plan view of the cart mover 10 with the hitch 40 positioned to engage the opposed lateral sides of a cart 65 (which, as shown in FIG. 24, is a flat bed hand truck or cart, but may be any other type of cart (including bossie carts) for carrying such items as food, beverages, consumer goods, items of manufacture or process, etc.), the length of the center support 70 is fixed and the jaws 75, 80 are horizontally displaceable along the center support 70. This arrangement allows the jaws 75, 80 to converge towards each other to engage the opposed lateral sides of the cart 65.

In use, the cart mover 10 approaches an end of the cart 65 with the jaws 75, 80 displaced apart from each other to the maximum extent (see FIGS. 24 and 25). The end of the cart 65 is positioned between the jaws 75, 80 such that each jaw 75, 80 is immediately adjacent a lateral side of the cart 65 and the face 205 of the center support 70 is immediately adjacent the end side of the cart 65. The operator utilizes a button on the control handle 210 on the tiller 30 to actuate the jaws 75, 80, which converge towards each other until each jaw 75, 80 is brought into solid contact with its respective lateral side of the cart 65. The hitch 40 is now secured to the cart 65. To release the jaws 75, 80 from the lateral sides of the cart 65, the operator utilizes another button to actuate the jaws 75, 80 to diverge.

In another embodiment similar to the embodiment illustrated in FIGS. 24 and 25, the jaws 75, 80 are both fixed and the length of the center support 70 is adjustable so the displacement between the jaws 75, 80 is adjustable. Thus, the length of the center support 70 can be decreased to bring the jaws 75, 80 into contact with the lateral sides of the cart 65.

In one embodiment, as indicated in FIG. 25, the face of each jaw 75, 80 is generally planar and has a protective belting 90 that increases the frictional contact between a jaw 75, 80 and its respective lateral side of the cart 65. In other embodiments, each jaw 75, 80 has a groove or other feature in its face for mating with a frame post or other structural feature of the cart 65 to help maintain the engagement between the cart 65 and the jaws 75, 80 and prevent the cart 65 from moving forwardly or rearwardly relative to the cart mover 10.

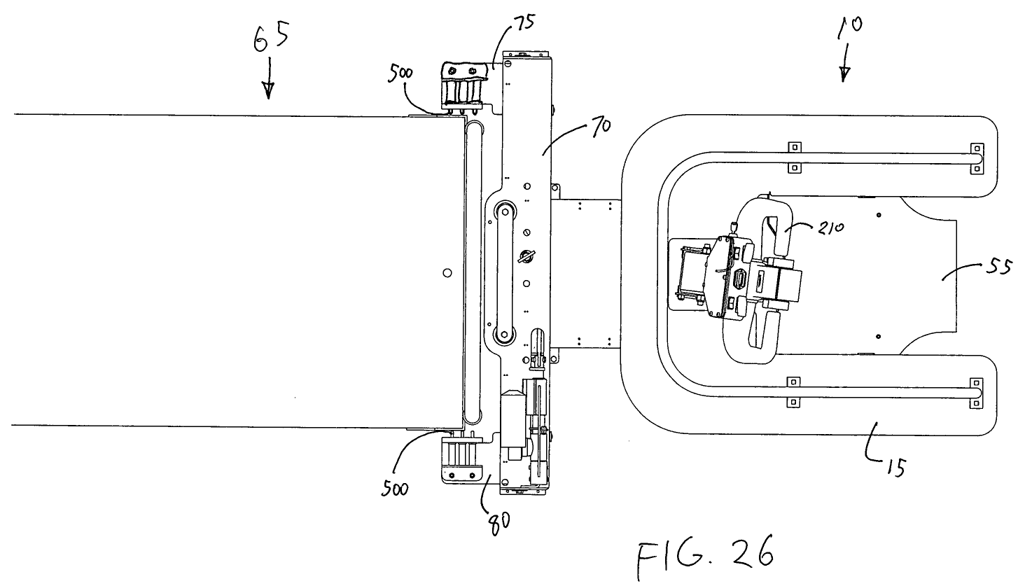

In one embodiment, as shown in FIG. 26, which is a plan view of the cart mover 10 with the hitch 40 positioned to engage the opposed lateral sides of a cart 65, each jaw 75, 80 is equipped with a plurality of telescoping fingers 500 that extend from the face of each jaw 75, 80. As indicated in FIGS. 27, 28, and 29, which are, respectively, plan, side elevation and exploded isometric views of the telescoping finger equipped jaws 75, 80 shown in FIG. 26, the jaws 75, 80 each have two rows of three fingers 500. In other embodiments, the jaws 75, 80 have a greater or lesser number of rows and a greater or lesser number of fingers 500 per row.

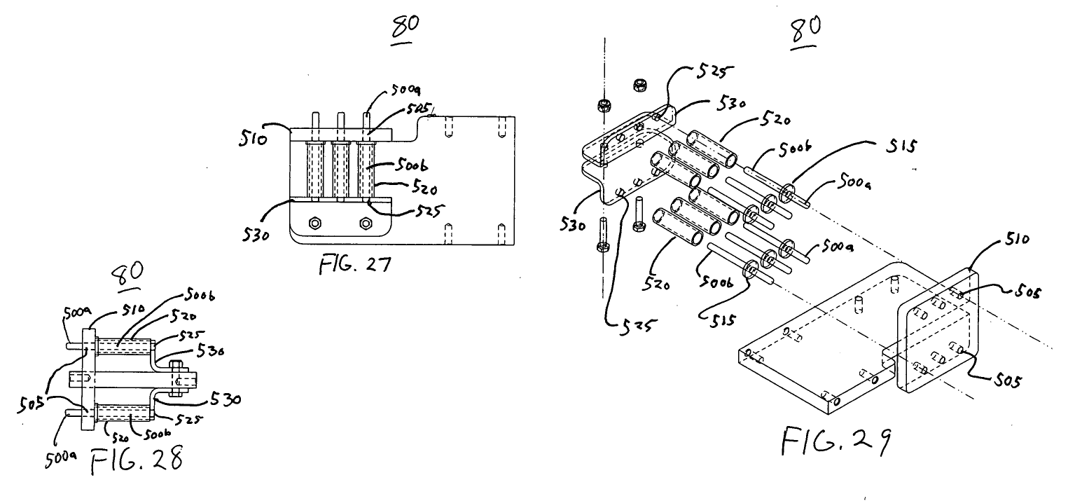

As shown in FIG. 29, each pin 500 has a collar 515 that divides the pin 500 into a front section 500a and a rear section 500b. Each front section 500a extends through a hole 505 in the faceplate 510 of the jaw 75, 80. Each rear section 500b passes through a spring 520 into a hole 525 in a spring holder 530.

Each pin 500 is rigid and is able to resist bending that could result from rough encounters with the structure of a cart 65. The fit between each pin 500 and its respective holes 505, 525 is relatively close to maintain the pin 500 perpendicular to its face plate 510. The pins 500 and holes 505, 525 have smooth finishes that allow the pins 500 to smoothly displace back and forth within the holes 505, 525.

Each spring 520 acts against a collar 515 and a spring holder 530 to bias its respective pin 500 forwardly such that the front section 500a extends from the face plate 510 as illustrated in FIGS. 26, 27 and 28. As best understood from FIGS. 26 and 27, when the jaws 75, 80 converge towards each other, some of the pins 500 will encounter structural features of the cart 65 and other pins 500 will not. The pins 500 that encounter a structural feature of the cart 65 will be forced back into the jaw 75, 80 so they no longer extend fully from the faceplate 510. The pins 500 that do not encounter a structural feature of the cart 65 will continue to fully extend from the faceplate 510.

Where a jaw 75, 80 is generally centered along a cart structural feature (e.g., a post of the cart frame) and the jaws 75, 80 are converged towards each other to bring the jaws into contact with their respective lateral sides of the cart 65, the center pins 500 will be forced back into the jaws 75, 80 and the extreme front and rear pins 500 will remain extended, thereby forming a barrier to the front and rear of the cart structural feature. This, in addition to the contact between the faceplates 510 of the jaws 75, 80 and the lateral sides of the cart 65, prevents the cart 65 from shifting forward or backward relative to the cart mover 10.

It is preferred that in normal operation of a machine with a steerable wheel, at least one wheel or castor is fixed (i.e., non-swivel). The fixed wheel or castor may be on the cart 65 or on the cart mover 10. To allow for carts 65 having no fixed castors, the cart mover 10 has an electrically actuated auto-steer swivel castor mechanism 220. The auto-steer swivel castor mechanism 220 of the subject invention is described with reference to FIGS. 10-14. FIG. 10 is a plan view of the auto-steer mechanism 220 in the open position. FIG. 11 is a plan view of the auto-steer mechanism 220 in the closed position. FIG. 12 is a side elevation view of the auto-steer mechanism 220 in the open position. FIG. 13 is a side elevation view of the auto-steer mechanism 220 in the closed position. FIG. 14 is a side perspective view of the auto-steer mechanism 220 in the open position.

As shown in FIGS. 10-14, the auto-steer mechanism 220 includes a mount surface 225, a castor pivot shaft 230, a castor 25, an electric actuator 235, a cam 240 and bearing studs 245. The castor 25 is pivotally mounted via the pivot shaft 230 to the mount surface 225. The bearing studs 245 are coupled to, and on both side of, the pivot shaft 230. The cam 240 is pivotally pinned to the mount surface 225. The cam 240 has an edge 250 for engaging the bearing studs 245. The cam 240 pivotally displaces in a plane that is perpendicular to the axis of the bearing studs 245.

To fix the castor 25 to prevent it from pivoting about its pivot shaft 230, the electric actuator 235, which is actuated by a button on the control handles 210 of the tiller 30, extends its shaft 255. The shaft 255 causes the cam 240 to pivot about its pivot point 260, bringing the edge 250 against the bearing studs 245. As the cam 240 presses against the bearing studs 245, the pivot shaft 230 rotates, thereby causing the castor 25 to lock into a front-oriented position, as illustrated in FIGS. 11 and 13. In one embodiment, the auto-steer mechanism 220 is provided with a lever to manually actuate the mechanism 220.

To release the castor 25 from being fixed in the front-oriented position, the operator presses the button on the control handles 210 and the electric actuator 235 retracts the shaft 255, which disengages the cam from the studs 245, as illustrated in FIGS. 10, 12, and 14. The castor 25 is once again free to pivot about the pivot shaft 230. In one embodiment, a single button on the control handles 210 actuates both the clamping hitch 40 and the auto-steer mechanism 220. In other embodiments, separate buttons actuate the clamping hitch 40 and the auto-steer mechanism 220.

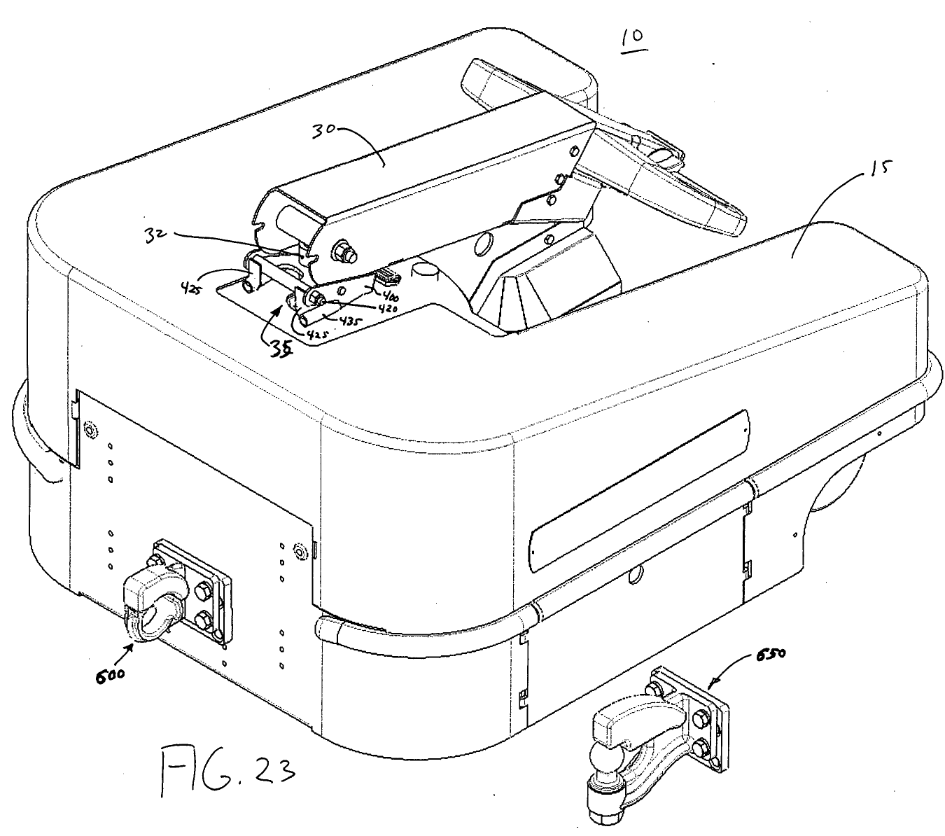

Because the brake mechanism is attached to the gear box/motor assembly 22, which, along with the steering assembly 32, rotates relative to the body 15 of the cart mover 10, it difficult to provide a manual brake release 300. The manual brake release mechanism 300 of the subject invention is described with reference to FIGS. 15-20. FIG. 15 is a back elevation view of the manual brake mechanism 300 with the brake locked. FIG. 16 is a back elevation view of the manual brake mechanism 300 with the brake released. FIG. 17 is a side elevation view of the manual brake mechanism 300 with the brake released. FIG. 18 is bottom view of the manual brake mechanism 300 with the brake locked. FIG. 19 is a bottom view of the manual brake mechanism 300 with the brake released. FIG. 20 is a side perspective view of the manual brake mechanism 300 with the brake released.

As shown in FIGS. 15-20, the manual brake release mechanism 300 includes a vertical shaft 305, a lever arm 310, and a cam 315. The shaft 305 is pivotally mounted in the pivot holes in a bracket 320. The lever arm 310 is perpendicularly attached to the top end of the shaft 305 and the cam 315 is attached to the bottom end of the shaft 305.

As illustrated in FIGS. 15-20, the cam 315 abuts against a brake release lever 325 mounted on the face of the brake housing 330. To release the brake, the lever arm 310 is moved to pivot the vertical shaft 305. This causes the cam 315 to rotate until it forces the brake release lever 325 sufficiently away from the face of the brake housing 330 to cause the brake to release, as shown in FIGS. 16, 17, 19, and 20. To reengage the brake, the lever arm 310 is moved in the opposite direction, causing the vertical shaft 305 to rotate in the opposite direction. This causes the cam 315 to rotate back to its original position, thereby allowing the brake release lever 325 to move back to the face of the brake housing 330.

The lever arm 310 is visible and accessible through a hole in the body 15 of the cart mover 10 when the steering assembly 32 is directed straight ahead. The cam 315, once moved to the position where it forces the brake release lever 325 to fully disengage the brake (shown in FIGS. 16, 17, 19, and 20), will stay in that position until its lever arm 310 is moved back to the brake engaged position (shown in FIGS. 15 and 18). Likewise, once the cam 315 is in the brake-engaged position, it will stay in that position until its lever arm 310 is moved.

Besides being equipped with the above-discussed manual break mechanism 300, in some embodiments, the cart mover 10 will also be equipped with an electrically actuated breaking system. Additionally, in some embodiments, the cart mover 10 will also be equipped with a dynamic or regenerative electrical breaking system.

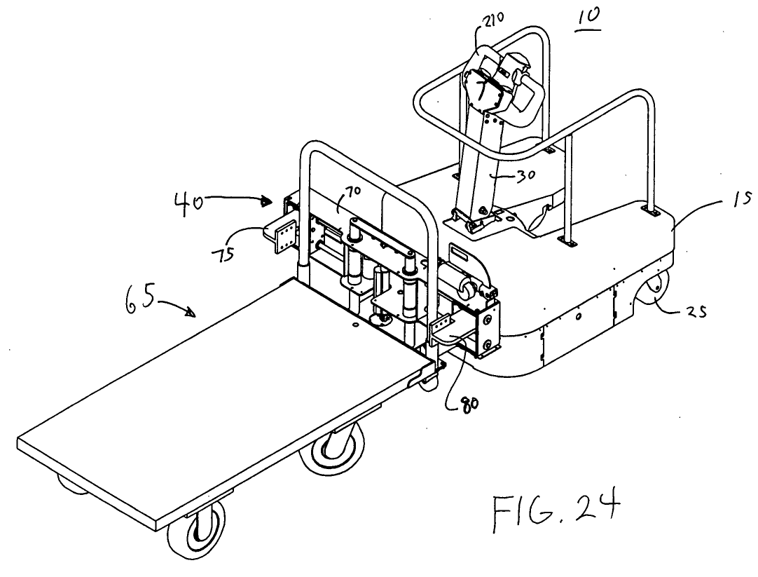

To describe the tiller latch 35 of the subject invention, reference is now made to FIGS. 21-23. FIG. 21 is a rear perspective view of the tiller latch 35 engaged. FIG. 22 is a rear perspective view of the tiller latch 35 disengaged. FIG. 23 is a front perspective view of the cart mover 10 with the tiller latch 35 disengaged and the tiller 30 in a horizontal position.

As shown in FIGS. 21 and 22, the tiller latch 35 includes a bracket 400 that is secured to the steering assembly 32. The bracket 400 includes a front side 405 and two lateral sides 410. The back ends of the lateral sides 410 have boltholes 415 for receiving a bolt 420 that pivotally secures the bracket 400 to the steering assembly 32. Spring abutments 425 extend from each rearward side of the tiller latch 35 (see FIG. 23). A spring finger 430 angles off of the bottom of each lateral side 410, near the front of each lateral side 410. A spring 435 resides between each spring abutment/finger combination 425, 430. A tab 440 protrudes from the side of each lateral side 410 to engage with a slot 445 in the arcuate bottom 447 of the tiller 30, thereby holding the tiller 30 in a fixed position. In one embodiment, as shown in FIG. 21, there will be multiple slots 445, thereby allowing the tiller 30 to fixed in several different orientations. In another embodiment, there will only be one set of slots 445, which will be oriented to only allow the tiller 30 to be fixed in a vertical orientation.

As shown in FIGS. 21 and 22, to disengage the tabs 440 from the slots 445 to allow the tiller 30 to be laid horizontal as shown in FIG. 23, downward pressure is applied (for example, by an operator's foot) to the front side 405. This causes the bracket 400 to pivot downward about the bolt 420, which causes the spring 435 to compress and the tabs 440 to disengage the slots 445. The tiller 30 can then be pivoted to a new position as, for example, shown in FIG. 23. Where the arcuate bottom 447 of the tiller 30 has multiple slots 445, as shown in FIG. 21, the tiller 30 can be secured in the new position by allowing the spring 435 to force the bracket 400 back up so the tabs 440 enter another set of slots 445.

In one embodiment, as shown in FIG. 23, the tiller 30 can be operated when the tiller 30 is in a horizontal position. In this tiller arrangement, the operator pulls on the handle of the tiller 30 as he walks in front of the cart mover 10. This arrangement also allows facilitates storage and shipment of the cart mover 10.

As indicated in FIG. 23, other hitches besides the clamping hitch 40 may be employed with the cart mover 10. For example, FIG. 23 depicts the cart mover 10 with a pintle hitch 600 for attaching to the bossie carts 65. The cart mover 10 may also be mounted with a ball hitch 650.

The battery charge monitor is located near the top of the tiller 30. The controller status pin on the controller is connected to the ground terminal on the battery charge monitor. When the controller is operating normally, the controller holds the status pin electrical potential at ground allowing normal battery charge monitor display with LED's.

If a status signal needs to be displayed, the controller raises and lowers the electrical potential in a predetermined pattern. When the potential is raised, the electrical potential on the battery monitor compared to the battery monitor positive terminal is insufficient to light the display and the display goes out. When the potential is lowered, the electrical potential on the battery monitor compared to the battery monitor positive terminal is now sufficient to light the display and the display is visible. The predetermined pattern of display is identified in the controller manual and is reprinted in the operators' manual for reference by the operator.

For each embodiment of the clamping hitch 40, as illustrated in FIGS. 1-9 and 24-26 and as discussed above, the operator may use a button or switch on the control handle 210 of the tiller 30 to actuate the jaws 75, 80 to converge or diverge. A similar switch or button may also be used to actuate the auto-steer mechanism 220. In addition to these automatic controls, the cart mover 10, in one embodiment, will also include controls and features as disclosed in U.S. patent application Ser. No. 10/280,157, filed Oct. 25, 2002, entitled “Hospital Bed Power-Assist,” which is hereby incorporated by reference herein in its entirety. Although the present invention has been described with reference to preferred embodiments, persons skilled in the art will recognize that changes may be made in form and detail without departing from the spirit and scope of the invention.

We claim:

1. A device for assisting an operator with rollably moving a cart along a surface, wherein the cart has a frame mounted on wheels and at least one surface adapted to support containers that include at least some liquid, the device comprising:
a body rollably supported by a drive wheel and a castor wheel;
a motor adapted to power the drive wheel;
a steering mechanism adapted to control the travel direction of the device; and
a clamp hitch adapted to engage the cart.

2. The device of claim 1, wherein the body comprises an operator platform.

3. The device of claim 1, wherein the steering mechanism comprises a tiller pivotally attached to the body.

4. The device of claim 3, wherein the drive wheel is pivotally attached to the body and pivoting the tiller causes the drive wheel to pivot about a vertical axis.

5. The device of claim 4, wherein the drive wheel and the tiller are pivotable about the same vertical axis.

6. The device of claim 1, wherein the drive wheel includes a hub and the motor is mounted therein.

7. The device of claim 1, further comprising a means for selectively fixing the castor to prevent it from pivoting about a vertical axis.

8. The device of claim 1, wherein the castor includes a vertical pivot shaft with a bearing surface and the device further comprises an actuator operably coupled to a cam, wherein the actuator is adapted to bring the cam into contact with the bearing surface, thereby preventing the castor from pivoting about the vertical pivot shaft.

9. The device of claim 8, wherein the bearing surface is two or more vertical bearing studs operably coupled to the vertical pivot shaft.

10. The device of claim 1, wherein the clamp hitch comprises:
a center structure having a first end and a second end;
a first jaw operably coupled to the first end;
a second jaw operably coupled to the second end; and
a mechanism adapted to cause the jaws to engage the cart.

11. The device of claim 10, wherein the first jaw is fixedly secured to the first end, the second jaw is pivotally secured to the second end, and the mechanism includes a linkage adapted to pivotally move the second jaw into engagement with the cart.

12. The device of claim 11, wherein the clamp hitch further comprises a secondary hitch pivotally secured to the center structure between the first and second ends.

13. The device of claim 10, wherein the first jaw is pivotally secured to the first end, the second jaw is pivotally secured to the second end, and the mechanism includes a linkage adapted to pivotally move the first and second jaws into engagement with the cart.

14. The device of claim 13, wherein the clamp hitch further comprises a secondary hitch pivotally secured to the center structure between the first and second ends.

15. The device of claim 10, wherein the first jaw is fixedly secured to the first end, the second jaw is fixedly secured to the second end, and the center structure is adapted to decrease in length to cause the convergence of the first and second jaws.

16. The device of claim 10, wherein the first jaw is adapted to displace along the center structure from the first end towards second end to cause the convergence of the jaws.

17. The device of claim 16, wherein the second jaw is adapted to displace along the center structure from the second end towards first end to cause the convergence of the jaws.

18. The device of claim 10, wherein at least one of the jaws includes a plurality of pins biased to extend from a jaw faceplate.

19. The device of claim 1, wherein the cart is a bossie cart.

20. The device of claim 1, wherein the cart is adapted for transporting containers of milk in a milk processing plant.

21. A device for assisting an operator with moving a cart along a surface, wherein the cart has a frame mounted on wheels or an air bearing, at least one product supporting surface, and at least two opposed sides, the device comprising:
a body rollably supported by a drive wheel and a castor wheel;
a motor adapted to power the drive wheel;
a steering mechanism adapted to control the travel direction of the device; and
a clamp hitch including a first jaw and a second jaw adapted to engage the opposed sides of the cart.

22. The device of claim 21, wherein the clamp hitch further comprises
a center structure having a first end and a second end, wherein the a first jaw is operably coupled to the first end and the second jaw is operably coupled to the second end; and
a mechanism adapted to cause the jaws to engage the opposed sides of the cart.

23. The device of claim 22, wherein the first jaw is fixedly secured to the first end, the second jaw is pivotally secured to the second end, and the mechanism includes a linkage adapted to pivotally move the second jaw towards the first jaw.

24. The device of claim 23, wherein the clamp hitch further comprises a secondary hitch pivotally secured to the center structure between the first and second ends.

25. The device of claim 22, wherein the first jaw is pivotally secured to the first end, the second jaw is pivotally secured to the second end, and the mechanism includes a linkage adapted to pivotally move the first and second jaws towards each other.

26. The device of claim 25, wherein the clamp hitch further comprises a secondary hitch pivotally secured to the center structure between the first and second ends.

27. The device of claim 22, wherein the first jaw is fixedly secured to the first end, the second jaw is fixedly secured to the second end, and the center structure is adapted to decrease in length to cause the convergence of the first and second jaws.

28. The device of claim 22, wherein the first jaw is adapted to displace along the center structure from the first end towards second end to cause the convergence of the jaws.

29. The device of claim 28, wherein the second jaw is adapted to displace along the center structure from the second end towards first end to cause the convergence of the jaws.

30. The device of claim 29, wherein at least one of the jaws includes a plurality of pins biased to extend from a jaw faceplate.

31. The device of claim 22, wherein the cart is adapted for transporting containers of beverages in a beverage processing plant.

32. The device of claim 31, wherein beverage is milk and the beverage processing plant is a milk processing plant.

33. The device of claim 22, wherein the cart is adapted for transporting items of manufacture in a manufacturing plant.

34. A method for assisting an operator with moving a cart along a surface wherein the cart has a frame mounted on wheels or an air bearing and at least two opposed sides, the method comprising:
approaching said cart with a cart mover including a drive wheel and a hitch with a pair of opposed jaws;
positioning the opposed sides of the cart between the pair of opposed jaws;
converging the jaws towards each other until the jaws contact the sides;
actuating the drive wheel to move the cart along a surface wherein the cart is supported by the wheels or air bearing as the cart is moved.

35. The method of claim 34, further comprising loading the cart with at least one container of milk.

36. The method of claim 34, further comprising using a tiller to change the travel direction of cart mover.

37. The method of claim 34, further comprising bringing a plurality of pins into contact with the opposed sides of the cart when the jaws converge.

38. The method of claim 34, further comprising pivoting at least one of the jaws when the jaws converge.

39. The method of claim 34, further comprising translating at least one of the jaws linearly and horizontally when the jaws converge.

40. A device for assisting an operator with moving a cart along a path, wherein the cart has a frame mounted on wheels or an air bearing, at least one product supporting surface, and at least two opposed sides, the device comprising:
a means for powering the device along the path;
a means for steering the device; and
a means for engaging a cart.

41. The device of claim 40, wherein the engaging means includes a means for clamping the device to the cart.
